(19) United States
(12) Patent Application Publication
(10) Pub. No.: US 2026/0318770 A1
(43) Pub. Date: Oct. 15, 2026

(54) A SYSTEM AND METHOD FOR ACOUSTIC DETECTION OF A CHANGE IN MOISTURE

(71) Applicant: CleanGuard AB, Nacka Strand (SE)

(72) Inventors: Fredrik MAGNUSSON, Saltsjö-boo (SE); Gustav FRYKHOLM, Stockholm (SE)

(21) Appl. No.: 19/485,714

(22) PCT Filed: May 14, 2024
(86) PCT No.: PCT/SE2024/050465

§ 371 Date: Nov. 19, 2025

(30) Foreign Application Priority Data
May 22, 2023 (SE) 2350610-8

(51) Int. Cl. G01M 3/24

(52) U.S. Cl. CPC G01M 3/24

(57) ABSTRACT

A system for acoustic detection of a change in moisture, the system comprising: at least one converting element an acoustic sensor configured to be mechanically connected to a structure and a processor coupled to the acoustic sensor wherein the at least one converting element comprises an actuating portion with at least one material having a hygroscopic property, such that a change in moisture causes a movement of the actuating portion which movement causes the converting element to generate a characteristic sound and induce the characteristic sound into the structure (50), wherein the acoustic sensor is configured to register the characteristic sound generated by the at least one converting element as structure-borne sound propagating through the structure and the processor is configured to detect the change in moisture based on the characteristic sound registered by the acoustic sensor.

### TECHNICAL FIELD

The present disclosure relates to system for acoustic detection of a change in moisture and a method for acoustic detection of a change in moisture. More specifically, the present disclosure relates to a system and method for acoustic detection of a change in moisture as defined in the introductory parts of the independent claims.

### BACKGROUND ART

That leakages can cause serious damage if not detected in time is commonly known, irrespective of the application area, and there are several different solutions for detecting leakages. However, a problem with many solutions is that they are configured, such that they only detect the leakage when a significant amount of liquid has leaked, and perhaps already has caused some damage. It is also apparent that most solutions focus on detecting sudden large leakages, which could cause the most severe damages, whereas small leakages (micro-leakages) often takes longer to detect.

The complexity of different detectors on the market may differ and also how the solutions attract attention to the detected leakage situation. As an example, patent U.S. Pat. No. 3,874,223 discloses a detector element, which is responsive to contact with a liquid such that it rotates itself or another element and thereby causes a signal generation means to indicate that a liquid has been detected. Also, patent GB2410561 B discloses a leak detector, which changes color on contact with a fluid. The visible color change draws attention to the leakage, which can be rectified. The detector could also include an audible and/or light emitting device for attracting attention.

While the prior art addresses some of the problems associated with leakage detection or changes in moisture in general, they often fail to provide a compact and space-saving solution, which is simple and easy to assemble and to use and which detects leakages, specifically micro-leakages, at an early stage. There is thus a need for an improved system for detection of change in moisture.

### SUMMARY

It is an object of the present disclosure to mitigate, alleviate or eliminate one or more of the deficiencies and disadvantages in the prior art and solve at least one of the current problems.

It is a particular object of the present disclosure to provide a system for acoustic detection of a change in moisture, which is simple, compact and easy to assemble and use.

Another object of the present disclosure is to provide a system for acoustic detection of a change in moisture, which is configured to detect leakages, specifically micro-leakages, at an early stage.

According to a first aspect of the present disclosure, there is provided a system for acoustic detection of a change in moisture. The system comprises: at least one converting element for converting a change in moisture to a characteristic sound; an acoustic sensor configured to be mechanically connected to a structure at a distance from the at least one converting element; and a processor coupled to the acoustic sensor, wherein the at least one converting element comprises an actuating portion with at least one material having a hygroscopic property, such that a change in moisture causes a movement of the actuating portion, which movement causes the converting element to generate a characteristic sound and induce the characteristic sound into the structure, wherein the acoustic sensor is configured to register the characteristic sound generated by the at least one converting element as structure-borne sound propagating through the structure and the processor is configured to detect the change in moisture based on the characteristic sound registered by the acoustic sensor. That the at least one material of the actuating portion has a hygroscopic property means that the material is configured to change size and/or shape in response to a change in moisture, which change in size and/or shape constitutes or causes the movement of the actuating portion.

It is to be understood that moisture is herein defined as water or other liquid diffused as vapour, within a solid, or condensed on a surface. Thus, a change in moisture will herein include everything from a change in humidity to a moisture increase caused by leakage of a liquid. The actuating portion may comprise at least one material having a hygroscopic property, such that a change in moisture causes a change in size and/or shape of the actuating portion and thereby causes a movement of the actuating portion. The actuating portion may comprise at least one hygroscopic material configured such that a change in moisture causes a movement of the actuating portion. The at least one hygroscopic material is prone to absorb or adsorb moisture and will then swell or expand and thereby cause a movement of the actuating portion.

A change in moisture can occur due to many reasons. For example, the change in moisture could be an increase of moisture due to a leakage or it could be an increase in humidity. Alternatively, the change in moisture could be a decrease in moisture. By means of the system as disclosed herein, a change in moisture will be converted to a characteristic sound induced into a structure, whereby the acoustic sensor registers the characteristic sound and the processor thereby detects the change in moisture. The converting element may be a mechanical construction. The converting element is a simple mechanical construction comprising one or more materials or geometries that reacts to a change in moisture (either increase or decrease) and thereby causes a part of the converting element to move. The converting element may be arranged in association with an object or in an environment where a change in moisture should be detected. The converting element comprising an actuation portion with at least one material with a hygroscopic property, will react to the change in moisture by starting a movement of the actuating portion and thereby causing a characteristic sound to be generated, which characteristic sound is induced into the structure. The converting element will thus at least temporarily physically interact with the structure, such that the characteristic sound propagates through the structure and can be registered by the acoustic sensor. By means of the structure, the acoustic sensor and the converting element will at least temporarily be mechanically connected. The structure-borne sound can propagate a long way and the electric acoustic sensor may be arranged far away from the converting element and the location of moisture change. Avoiding electrical components at the location of moisture changes is advantageous for safety reasons and it also allows the system to be used to detect moisture changes in environments where there is no electricity, as long as the acoustic sensor is mechanically connected (directly or indirectly) to a structure in said environment. Furthermore, the system allows multiple converting elements to be connected to the same structure and a single sensor and processor can thereby be used to detect change in moisture at different locations on/along the same structure. By having an acoustic sensor that registers the characteristic sound of the converting element as structure-borne sound, surrounding sounds and/or noise will not interfere with the registered sound compared to when using a microphone for detecting airborne sound. The characteristic sound generated by the converting element will this way easily be registered and a reliable system for detecting the change in moisture is achieved.

The shape and configuration of the converting element gives the characterising sound generated by the converting element. This way, the processor will be able to determine that the registered sound origin from the converting element and thus that a change in moisture has occurred at the location of the converting element.

The actuating portion of the converting element may be configured to react to a change in moisture above or below a certain moisture threshold. Thus, the movement of the actuating portion may occur when the moisture has changed above or below a certain moisture threshold. The movement of the actuating portion will cause the characteristic sound to be generated.

The converting element may comprise a sound-generating portion connected to the actuating portion. The movement of the actuating portion may affect and move at least a part of the sound-generating portion and the characteristic sound may thus be generated by the sound-generating portion upon actuation of the sound-generating portion by the actuating portion. The sound-generating portion may be configured to induce the characteristic sound into the structure. The sound-generating portion may comprise at least one contact portion configured to be arranged in physical contact with the structure. This way, the characteristic sound generated by the converting element will be induced into the structure via the contact portion.

According to an example of the present disclosure, the sound-generating portion comprises at least one vibrational element configured to be brought into vibration by the movement of the actuating portion, the configuration of the at least one vibrational element causing the characteristic sound to comprise at least one characteristic frequency and/or a plurality of frequencies forming a characteristic sequence of frequencies. The vibrational element may be directly or indirectly mechanically connected to the actuating portion. The vibrational element may be indirectly connected to the actuating portion by means of a mechanical bridge, such that the movement of the actuating portion causes the mechanical bridge to move, which causes the vibrational element to vibrate. Alternatively, the vibrational element may be arranged adjacent the actuating portion, such that the movement of the actuating portion cause the actuating portion to physically interact with or hit the vibrational element, and thereby bring the vibrational element into vibration. Alternatively, the actuating portion and the vibrational element are integrated in one unit, such that the movement of the actuating portion also moves the vibrational element and brings the vibrational element into vibration.

The movement of the actuating portion may itself cause generation of a characteristic sound indicating that a change in moisture has occurred. However, the vibrational element being brought into vibration by the movement of the actuating portion will add at least one characteristic frequency to the characteristic sound and the converting element will this way have a unique identity. The movement of the actuating portion may cause a sound pulse of short duration and the vibrational element may cause a reverberation giving the characterising sound its identity. The vibrational element may be referred to as a reverb element. In some embodiments, the system may be configured, such that detection by the acoustic sensor of the sound pulse caused by the actuating portion triggers the processor to perform a frequency analysis of a lingering sound following the sound pulse. This way, computationally demanding frequency analysis can be performed only in response to movement of the actuating portion of a converting element, thereby ensuring energy-efficient monitoring of the moisture.

The at least one vibrational element may comprise an elongated leg or tongue with a free end and be connected at the other end to the actuating portion or the sound-generating portion. The sound-generating portion of the converting element may comprise a plurality of vibrational elements.

The at least one vibrational element may comprise a vibrational portion extending between a pivot point and the free end of the vibrational element, wherein the converting element may comprise means for manually adjusting the length of the vibrational portion in order to manually affect at least one characteristic frequency and/or a plurality of frequencies forming a characteristic sequence of frequencies. Thus, by manually adjusting the length of the vibrational portion a specific and unique identity can be given to the converting element. This way, the converting element can be manufactured with a generic configuration and the user can individualise each converter element to generate different characteristic sounds. This means that a user having a plurality of converting elements, can adjust the length of the vibrational portion of each vibrational element of each converting element and that way create unique identities of the converting elements. The means for adjusting the length of the vibrational portion of the at least one vibrational element may comprise markings, dentations, fold lines or perforations for bending or removing a part of the vibrational portion, and that way adjust the length of the vibrational portion.

Alternatively, the means for adjusting the length of the vibrational portion of the at least one vibrational element may comprise a slider element movable along the length of the vibrational element. The slider element will connect the vibrational element with a fixed support structure and will thereby constitute the pivot point of the vibrational portion. The position of the slider element will thus determine the position of the pivot point of the vibrational element. By moving the slider element, the pivot point is moved and the length of the vibrational portion is adjusted.

The converting element may comprise an attachment portion for attaching the converting element on the structure or an object mechanically connected to the structure. The attachment portion may be configured as a clip, a snap-on mechanism or as a clamping mechanism. Alternatively, the attachment portion comprises adhesive for adhering the converting element to the structure. The attachment portion may also constitute the contact portion of the sound-generating portion.

The converting element may be a single unit where all parts and portions are integrally connected with each other. This will facilitate manufacturing, mounting and use of the converting element.

The actuating portion may comprise at least two materials having different hygroscopic properties. The at least two materials of the actuating portion having different hygroscopic properties typically involves a first part with a first material being prone to absorb or adsorb moisture and a second part with a second material being less prone to absorb or adsorb moisture. When the first part adsorbs or absorbs moisture, the first part will swell or expand. The converting element is suitably configured such that expansion of the first part will cause a movement of the second part. The expansion of the first part may cause the first part to apply a force on the second part, and thereby cause a movement of the second part. Similarly, a decrease in moisture may cause the first part to contract or shrink, which may cause a movement of the second part.

The structure may be a part of a piping system, a tube or hose, a table, a wall, a floor, a container, a shelf or any physical structure configured to enable propagation of sound through the structure. In one example, the structure is a piping system or similar and the at least one converting element may be arranged in vicinity of a pipe coupling, where the risk for leakage is increased. In another example, the structure is a floor underneath a water consuming machine, such as a washing machine or dishwasher, and the system is arranged to detect a leakage from such a machine. In yet another example, the system is arranged to detect when the moisture is decreased. For example, the converting element may be arranged on an inner wall of a container filled with liquid, wherein the converting element generates the characteristic sound when the level of liquid inside the container falls below the position of the converting element. In this case, the sensor can be arranged anywhere on the container wall, preferably on the outside.

According to an example of the present disclosure, the actuating portion comprises a snapping mechanism configured to perform a snapping movement into a stable state of the snapping mechanism in response to the change in moisture. The snapping movement is a sudden movement caused by a quick release of energy that is either pre-stored as potential energy in the snapping mechanism or stored in the snapping mechanism in response to the change in moisture. The snapping movement may cause a characteristic sound to be generated and the sound-generating portion will induce the characteristic sound into the structure. When the actuating portion comprises a snapping mechanism configured to perform a snapping movement into a stable state of the snapping mechanism in response to the change in moisture, the at least one vibrational element may be configured to be brought into vibration by the snapping movement of the snapping mechanism. The sudden movement of the snapping mechanism will bring the vibrational element into vibration and cause the characteristic sound to comprise at least one characteristic frequency and/or a plurality of frequencies forming a characteristic sequence of frequencies.

The snapping mechanism may be a bi-stable mechanism configured with a snap-through instability, configured to perform the snapping movement between a first stable state and a second stable state of the bi-stable mechanism in response to the change in moisture. Such mechanism typically transitions rapidly between the two stable states and the rapid movement from one stable state into the other stable state will cause the characteristic sound to be generated. In embodiments employing at least one vibrational element, the rapid movement between the two stable states may bring the at least one vibrational element into vibration, causing the characteristic sound to comprise at least one characteristic frequency and/or a plurality of frequencies forming a characteristic sequence of frequencies.

According to an example of the present disclosure, the snapping mechanism of the actuating portion comprises a dome-shaped part configured to snap-through in response to the change in moisture. The snapping mechanism is this way configured with a snap-through instability, configured to perform the snapping movement between a first stable state and a second stable state of the bi-stable mechanism in response to the change in moisture, whereby the dome-shaped part is inverted. When the snapping movement occurs, the characteristic sound generated by the sound-generating portion upon movement of the actuating portion, will be induced into the structure via the sound-generating portion, which is mechanically connected to the structure. The actuating portion may comprise a first part with an absorbing or adsorbing material, which will expand or contract in response to a change in moisture. The dome-shaped part of the snapping mechanism may constitute the second part of the actuating portion as mentioned previously herein. The first part is typically arranged underneath the dome-shaped second part, such that expansion of the first part will cause the first part to press on the second part, such that it eventually is inverted. The first part may thus actuate the snapping movement of the snapping mechanism. The sound-generating portion may be mechanically connected to the structure by means of attaching the contact portion of the sound-generating portion to the structure with adhesive. The contact portion may be essentially flat. Alternatively, the contact portion of the sound-generating portion may be configured to be clamped around the structure. Thus, the contact portion may at least partially surround a part of the structure. The sound-generating portion of the converting element may further comprise at least one vibrational element.

The snapping mechanism of the actuating portion may alternatively comprise at least one somewhat resilient part and at least one engagement element arranged to move in relation to each other in response to a change in moisture, such that the resilient part eventually disengages from the at least one engagement element and springs back, thereby causing the snapping movement. The snapping mechanism may thus be configured so that the at least one resilient part and the at least one engagement element are engaged in a normal state of the converting element. When there is a change in moisture, the at least one resilient part will build up energy as it flexes and/or bends against the at least one engagement element. As the at least one resilient part and the at least one engagement element continue to move in relation to each other, the resilient part will eventually quickly release the energy and spring back at the other side of the at least one engagement element. The at least one resilient part may thus have a stable state on each side of the at least one engagement element. In this way, the snapping mechanism may be said to function as a ratchet device or similar. The at least one resilient part and the at least one engagement element may be arranged to move in opposite directions, towards each other. The at least one resilient part may be an integral part of the actuating portion. The at least one engagement element may be a groove, recess or bulge. The at least one resilient part may be a resilient protrusion, spike, needle, tooth, tip or similar. The snapping mechanism may comprise a plurality of engagement elements, such as a plurality of grooves, recesses, bulges, or an undulating pattern. In the event that the snapping mechanism comprises two resilient parts, they may be arranged such that the order in which they engage/disengage with the at least one engagement element will affect the characteristic sound that is generated, whereby the processor can determine in which direction the resilient parts are moving based on the characteristic sound. This can be used in determining, for example, if the change in moisture is an increase or a decrease.

The converting element may be elongated and essentially flat in a non-mounted state. The actuating portion may be elongated with a length similar to, or longer than, a circumference of the structure, such that the actuating portion can encircle the structure. This could be advantageous when the structure is a pipe, tube, hose or similar. The actuating portion may be flexible such that it can be wrapped around a structure. In such case, the actuating portion may constitute the attachment portion. In one example, the converting element is essentially L-shaped in a non-mounted state, wherein the actuating portion and the sound-generating portion are arranged perpendicularly to each other in the same plane. The longest part of the converting element may be the actuating portion and the other part may be the sound generating portion. Alternatively, the converting element is elongated and straight, wherein at least a part of the sound-generating portion is a prolongation of the actuating portion or vice versa. Thus, at least a part of the sound-generating portion may be arranged at one end of the converting element and the actuating portion at the other end of the converting element. Specifically, at least one vibrational element of the sound-generating portion may be arranged at one end of the converting element and the actuating portion at the other end of the converting element. The sound-generating portion and/or the vibrational element of the sound-generating portion may be configured to extend in parallel with the longitudinal extension of the structure or perpendicularly to the longitudinal extension of the structure on which it is arranged.

According to one example of the present disclosure, the actuating portion is configured to encircle the structure such that there is an overlapping section where a first end of the actuating portion and a second end of the actuating portion are overlapping each other, wherein the resilient part and the at least one engagement element are arranged on sides of the first end and the second end of the actuating portion facing each other in the overlapping section. This way, the resilient part and the at least one engagement element will interact in the overlapping section. In the overlapping section, the first end may be arranged closest to the structure and may be referred to as a lower part of the actuating portion, and the second end may be referred to as an upper part of the actuating portion.

In one example, the resilient part protrudes downwards from the upper part of the actuating portion and the engagement element(s) are arranged on the lower part of the actuating portion, facing the upper part of the actuating portion in the overlapping section. In another example, the resilient part protrudes upwards from the lower part of the actuating portion and the engagement elements are arranged on the upper part of the actuating portion in the overlapping section. In order for the resilient part and the engagement element to interact with each other in the overlapping section, they should be arranged on opposite sides of the actuating portion.

The actuating portion having at least one material with a hygroscopic property may cause a movement of the actuating portion in response to a change in moisture, such that the diameter of the encircling actuating portion changes and the resilient part and the at least one engagement element moves in relation to each other. The actuating portion with the snapping mechanism may comprise the at least one hygroscopic material. In one example, the actuating portion comprises an adsorbing first part or layer arranged closest to the structure and a second part comprising the snapping mechanism and arranged to encircle the structure and forming the overlapping section. The first part is configured to expand or contract in response to the change in moisture, whereby the diameter of the encircling second part of the actuating portion changes and the resilient part and the at least one engagement element moves in relation to each other. With an adsorbing first part arranged closest to the structure, an increase in moisture in association with the structure will quickly result in an expansion of the first part. When the first part expands, it will push the encircling second part of the actuating portion outwards away from the structure and the diameter of the second part of the actuating portion will increase. This way, the upper part and the lower part of the actuating portion in the overlapping section will start moving in relation to each other. As the first part continues to absorb moisture and expand, the resilient part will eventually disengage from the at least one engagement element and spring back to the stable state at the other side of the at least one engagement element, thereby causing the snapping movement. Similarly, with an adsorbing first part arranged closest to the structure, a decrease in moisture in association with the structure will quickly result in a contraction of the first part. When it contracts, the diameter of the second part of the actuating portion encircling the structure will decrease and the upper part and the lower part of the actuating portion in the overlapping section will start moving in relation to each other. This way, the resilient part will eventually disengage from the at least one engagement element and spring back to the stable state on the other side of the at least one engagement element, thereby causing the snapping movement. The snapping movement will cause the sound-generating portion to generate the characteristic sound. The sound-generating portion comprises at least one contact portion configured to be arranged in physical contact with the structure, either temporarily or constantly. In this example, the sound-generating portion may comprise at least one contact portion extending perpendicularly to the longitudinal extension of the actuating portion and/or the sound-generating portion, towards the structure. When the snapping movement occurs, the contact portion will induce the characteristic sound into the structure and thereby indicate that a change in moisture has occurred. The snapping movement will also bring the at least one vibrational element into vibration, which will cause the characteristic sound to comprise at least one characteristic frequency. This way, the acoustic sensor will register the characteristic sound and the processor will detect that a change in moisture has occurred.

The converting element may comprise metal and the resilient part may be a punched spike, tongue or tooth in the metal, extending essentially perpendicularly to the main extension plane of the converting element. The actuating portion may comprise a plurality of engagement elements, configured as a recess pattern formed in the metal. Such recesses are arranged to extend perpendicularly to the longitudinal extension of the actuating portion.

The converting element may be configured, such that the actuating portion is brought into movement both when the moisture level changes from a normal moisture level and when the moisture level returns to normal. This way, the same converting element can be used multiple times. As an example, the converting element may be configured to react when the moisture increases, indicating a risk of leakage. A snapping movement of the actuating portion may occur, whereby the sensor registers the characteristic sound and the processor detects the change in moisture. The operator may then perform some sort of action to avoid problem, for example stop the leakage. When the moisture level in vicinity of the converter element decreases to a normal moisture level, the converting element may react again and generate a characteristic sound registered by the sensor. The movement of the actuating portion when the moisture level returns to normal may be in an opposite direction compared to the movement caused by the increase in moisture. The processor may then detect that the converting element has returned to its original state based on the registered characteristic sound and thus that the problem with too high moisture level no longer exists. The same is applicable when the converting element is configured to react to a decrease in moisture from a normal moisture level, and to a subsequent increase in moisture back to the normal moisture level.

The converting element may hence be configured such that the characteristics of the sound generated by the converting element depends on the direction of movement of the actuating portion. In some embodiments, in order for the converting element to generate different sounds for the different directions of movement of the actuating portion, the converting element may be configured to generate at least two different sounds sequentially when the actuating portion is brought into movement, wherein the sequence of the two different sounds will help determine if the movement of the actuating portion is caused by an increase in moisture or if it is caused by a decrease in moisture. For example, the converting element may be configured such that a movement of the actuating portion causes vibration of both a first vibrational element having a first characteristic frequency and a second vibrational element having a second characteristic frequency, wherein the order in which the first and second vibrational elements start to vibrate depends on the direction of movement of the actuating portion. This way, the direction of movement of the actuating portion can be determined by the processor based on the order of the frequencies registered by the acoustic sensor.

As previously described, the system may comprises a plurality of converting elements, wherein the characteristic sound created by each converting element is associated with a unique identity and/or position of the converting element, the processor being configured to determine a location of the change in moisture based on the unique identity and/or position of the converting element having created the registered characteristic sound. As an example, the system may comprise a plurality of converting elements arranged at different locations in a piping system. Since they all are arranged on the same piping system, a single sensor attached to the same piping system can register any sound generated by any of these converting elements. Depending on the location of the converting element, the characteristic sound from the converting element propagating through the structure will be different. Additionally or alternatively, each converting element may have a sound generating portion configured differently from the others, for example with differently configured vibrational elements, such that each converting element is associated with a unique identity. Thus, when leakage occurs somewhere along the piping system, the corresponding converting element will generate a characteristic sound and the processor will not only detect that a change in moisture has occurred, but can also, based on the unique identity of the converting element, determine the location of the converting element and thus the location of the leakage.

According to another aspect of the present disclosure, a method for acoustic detection of a change in moisture is provided. The method comprises providing at least one converting element for converting the change in moisture to a characteristic sound, wherein the converting element comprises an actuating portion with at least one material having a hygroscopic property, such that a change in moisture causes a movement of the actuating portion, which movement causes the converting element to generate a characteristic sound and induce the characteristic sound into the structure; registering the characteristic sound generated by the converting element as structure-borne sound propagating through the structure by means of an acoustic sensor mechanically connected to the structure at a distance from the at least one converting element; and detecting the change in moisture based on the characteristic sound registered by the acoustic sensor by means of a processor coupled to the acoustic sensor. The processor may receive signals from the acoustic sensor corresponding to the registered characteristic sound and the processor may detect a change in moisture based on the received signals.

It is to be understood that all features and advantages with regard to the system as disclosed herein is also applicable on the method for acoustic detection of a change in moisture by means of this system.

The converting element may comprise a sound-generating portion with at least one vibrational element configured to be brought into vibration by the movement of the actuating portion, the configuration of the at least one vibrational element causing the characteristic sound to comprise at least one characteristic frequency and/or a plurality of frequencies forming a characteristic sequence of frequencies, wherein the change in moisture is detected based on the at least one characteristic frequency and/or a plurality of frequencies forming a characteristic sequence of frequencies.

The vibrational element may comprise a vibrational portion extending between a pivot point and a free end of the vibrational element and the method may further comprise adjusting the length of the vibrational portion in order to manually affect at least one characteristic frequency and/or a plurality of frequencies forming a characteristic sequence of frequencies. This way, the user of the system can manually give each converting element a unique identity and facilitate the use of multiple converting elements on the same structure.

The step of detecting the change in moisture may comprise to determine a location of the change in moisture based on the unique identity and/or position of the converting element having created the registered characteristic sound.

It is to be understood that all features and advantages related to the system are also applicable on the method.

According to a another aspect of the present disclosure there is provided a computer program comprising computer-readable instructions which, when executed by a processor of a system for acoustic detection of a change in moisture as disclosed herein, causes the processor to perform the step of detecting the change in moisture based on a characteristic sound generated by a converting element and registered by an acoustic sensor of the system. The computer program may further comprise instructions for causing the processor of the system to perform any of, or any combination of, the method steps of the above-described method related to the processor.

The computer program or parts of the computer program may reside in a data storage medium of the acoustic sensor. In some embodiments, the computer program may be a distributed application comprising several computer program components configured to perform different steps of the above-described method. For instance, the computer program may comprise a first program component or application residing in the acoustic sensor, a second program component or application residing in the network server, and a third program component or application in form of a client application for presentation of data and interaction with a user, residing in a client device. In another example, the computer program may comprise a web application accessible via a web browser of the client device.

According to another aspect of the present disclosure there is provided a computer program product comprising at least one computer-readable medium, such as a non-transitory memory hardware device, storing the above mentioned computer program.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the appended claims.

### BRIEF DESCRIPTIONS OF THE DRAWINGS

The above objects, as well as additional objects, features and advantages of the present disclosure will be more fully appreciated by reference to the following illustrative and non-limiting detailed description of example embodiments of the present disclosure, when taken in conjunction with the accompanying drawings, of which:

FIG. 1 illustrates an exemplary embodiment of a system for acoustic detection of a change in moisture according to the present disclosure;

FIG. 2a-b illustrate a converting element according to examples of the present disclosure;

FIG. 3a-b illustrate a converting element according to examples of the present disclosure;

FIG. 4a-c illustrate a converting element according to examples of the present disclosure;

FIG. 5 illustrates a converting element according to an example of the present disclosure;

FIG. 6a-b illustrate a converting element according to an example of the present disclosure;

FIG. 7a-c illustrate details of a converting element according to examples of the present disclosure;

FIG. 8 illustrates a system for acoustic detection of a change in moisture according to an example of the present disclosure;

FIG. 9 illustrates a system for acoustic detection of a change in moisture according to an example of the present disclosure;

FIG. 10 illustrates an exemplary embodiment of a method for acoustic detection of a change in moisture according to the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided merely to fully convey the scope of the disclosure to the skilled person.

It is to be understood that the terminology used herein is for purpose of describing particular embodiments only, and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the terms “comprising”, “including”, “containing” and similar wordings are intended to be open-ended transitional terms that do preclude the possibility of additional elements or steps.

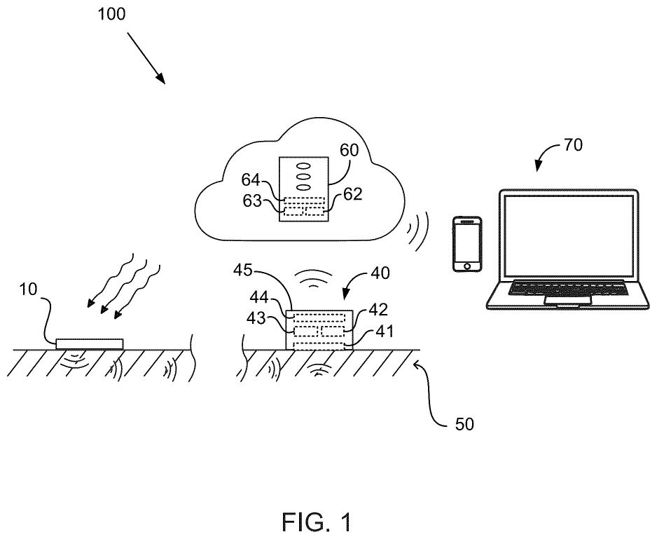

FIG. 1 schematically illustrates a system 100 for acoustic detection of a change in moisture according to an example of the present disclosure. The system 100 comprises at least one converting element 10 for converting a change in moisture to a characteristic sound. The system 100 also comprises an acoustic sensor 40 mechanically connected to a structure 50 at a distance from the at least one converting element 10. Furthermore, the system 100 comprises at least one processor 42, 62 coupled to the acoustic sensor 40. The converting element 10 comprises an actuating portion (not shown) with at least one material having a hygroscopic property, such that a change in moisture causes a movement of the actuating portion. The actuating portion thus comprises at least one material, which reacts to a change in moisture by causing a movement of the actuating portion. The movement of the actuating portion causes the converting element 10 to generate a characteristic sound and induce the characteristic sound into the structure 50. The acoustic sensor 40 is configured to register the characteristic sound generated by the converting element 10 as structure-borne sound propagating through the structure 50 and the at least one processor 42, 62 is configured to detect the change in moisture based on the characteristic sound registered by the acoustic sensor 40.

In response to detection of the change in moisture, the system 100 may be configured to notify a user of the change in moisture, e.g. by generating a local alarm or by informing the user of the detection of the change in moisture via a mobile electronic device 70 to which the acoustic sensor 40 is communicatively connectable. Thus, when the at least one processor 42, 62 has detected a change in moisture, this can be presented on a mobile electronic device of the user, such that the user is informed and can take action if something needs to be done to handle the detected change in moisture.

The acoustic sensor 40 comprises a housing 45, such as plastic housing, which is securely attached to the structure 50 to ensure tight mechanical coupling between the sensor housing 45 and the structure 50. The acoustic sensor 40 further comprises an acoustic sensor element 41 configured to register acoustic signals in form of structure-borne sound or vibrations propagating through the structure 50. The acoustic sensor element 41 may e.g. be a piezoelectric acoustic sensor element or a contact microphone for registering structure-borne sound in the structure 50. The acoustic sensor 40 further comprises a processor 42 and a data storage medium 43. The data storage medium 43 stores a computer program component which, alone or in collaboration with computer program components residing in one or more other devices to which the acoustic sensor 40 is connectable, constitutes a computer program for detection of a change in moisture.

In the illustrated example, the system 100 is a cloud-based system comprising a network server 60. The acoustic sensor 40 comprises a communication module 44 configured to communicate with a communication module 64 of the network server 60 using any known communication protocol. In some embodiments, the network server 60 is a web server connected to the Internet. The network server 60 further comprises a processor 62 and a data storage medium 63 storing a server-side component of the above mentioned computer program. The logic required for processing the registered acoustic signals and for determining whether a change in moisture has occurred based on the processed acoustic signals may reside in any of the acoustic sensor 40 or the network server 60. The network server 60 is configured to communicate information relating to the detection of the change in moisture to a client device 70, such as a stationary computer, a laptop, a tablet computer or a mobile phone. In some embodiments, the client device 70 may store a client application communicating with the server-side component of the computer program. This way, alerts and/or other information relating to detection of the change in moisture may be communicated from the network sever 60 to the client device 70 in the form of push notifications.

The converting element 10 is configured to react to the change in moisture and thereby generate a sound, which is induced into the structure 50. The converting element 10 is suitably a simple mechanical construction comprising materials and/or geometries, which will react to a change in moisture. The converting element 10 suitably does not include any electronic components or intelligence. The shape and configuration of the converting element 10 gives the characterising sound generated by the converting element 10. This way, the at least one processor 42, 62 of the system 100 will be able to determine that the registered sound origin from the converting element 10 and thus that a change in moisture has occurred.

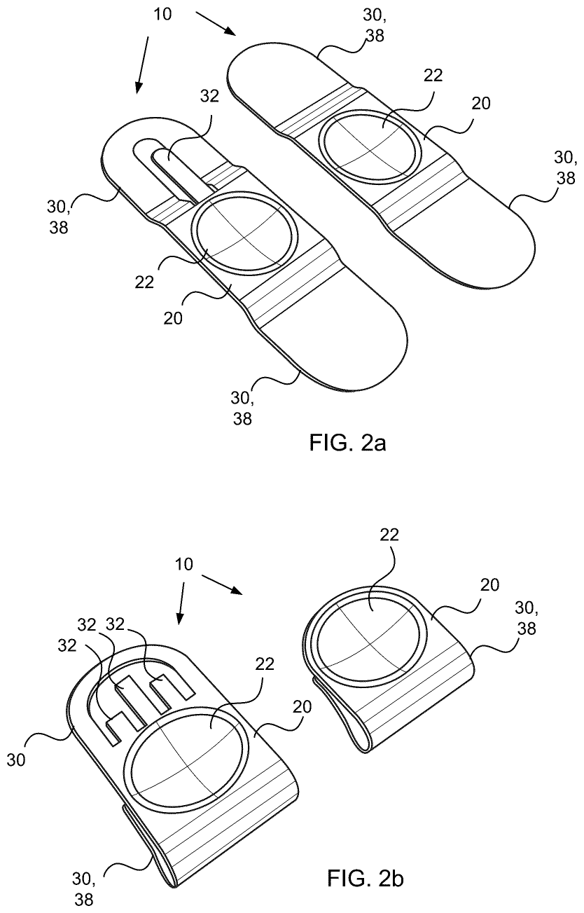

FIG. 2a-b schematically illustrates converting elements 10 according to examples of the present disclosure. The converting element 10 may form part of a system 100 for acoustic detection of a change in moisture according to FIG. 1. In these examples, the converting element 10 also comprises a sound-generating portion 30 connected to the actuating portion 20. The sound-generating portion 30 comprises at least one contact portion 38 configured to be arranged in physical contact with the structure 50. The sound-generating portion 30 is configured to generate the characteristic sound upon movement of the actuating portion 20 and induce the characteristic sound into the structure 50.

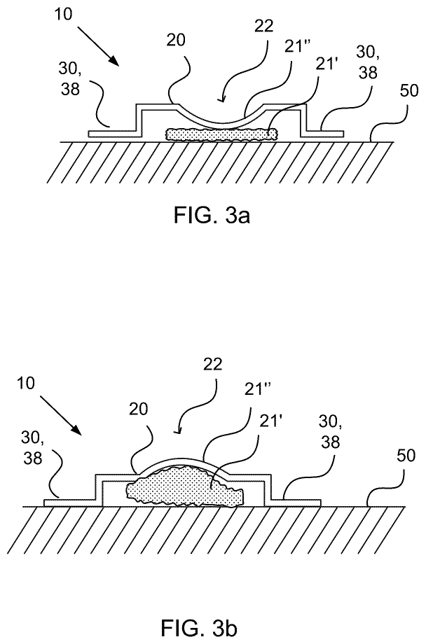

In FIGS. 2a and 2b the actuating portion 20 comprises a snapping mechanism 22 configured to perform a snapping movement into a stable state of the snapping mechanism 22 in response to the change in moisture. The snapping movement will propagate in the converting element 10 and cause the sound-generating portion 30 to generate the characteristic sound and induce the characteristic sound into the structure 50. The snapping mechanism 22 may be a bi-stable mechanism configured with a snap-through instability, configured to perform the snapping movement between a first stable state and a second stable state of the bi-stable mechanism in response to the change in moisture. The actuating portion 20 may comprise a first part (see FIG. 3a-b) with higher hygroscopicity (ability to absorb moisture) than a second part comprising the snapping mechanism 22, the first part being arranged to react to a change in moisture and as a response actuate the snapping mechanism 22 and thereby cause the snapping movement.

FIG. 2a shows an example of the converting element 10 where the sound-generating portion 30 extends on both sides of the actuating portion 20 and comprises two flat contact portions 38. The contact portions 38 are configured to be arranged in physical contact with the structure 50 and will this way induce the characterizing sound into the structure 50. The converting element 10 to the left in FIG. 2a also shows the sound-generating portion 30 comprising a vibrational element 32. The vibrational element 32 is configured to be brought into vibration by the movement of the snapping mechanism 22. The configuration of the vibrational element 32 causes the characteristic sound to comprise at least one characteristic frequency. The snapping mechanism 22 of the actuating portion 20 typically transitions rapidly between the two stable states and the rapid movement from one stable state into the other stable state will bring the vibrational element 32 into vibration and cause the contact portion 38 of the sound-generating portion 30 to induce the generated characteristic sound into the structure 50.

The converting elements 10 in FIG. 2b comprise a sound-generating portion 30 with a contact portion 38, which is folded to form a loop. The contact portion 38 of the sound-generating portion 30 is thus in these examples configured to at least partly encircle the structure 50 and thereby clamp the converting element 10 on the structure 50. In the left figure, the sound-generating portion 30 of the converting element 10 also comprises three vibrational elements 32. The three vibrational elements 32 have different lengths and will this way cause the characteristic sound to comprise at least three characteristic frequencies.

FIGS. 3a-b schematically illustrate a converting element 10 according to an example of the present disclosure. The converting element 10 may form part of a system 100 for acoustic detection of a change in moisture according to FIG. 1. The converting element 10 may be configured as in FIG. 2a-b with regard to the actuating portion 20.

FIGS. 3a-b illustrate how the actuating portion 20 of the converting element 10 reacts when there is a change in moisture. The actuating portion 20 comprises a first part 21′ with a first material being prone to absorb or adsorb moisture and a second part 21″ which is essentially dome shaped. The dome-shaped second part 21″ constitutes the snapping mechanism 22 of the converting element 10. In its normal state shown in FIG. 3a, the second part 21″ is essentially concave and the contact portion 38 of the sound-generating portion 30 is mechanically connected to the structure 50. When the moisture level increases, the first part 21′ will absorb or adsorb the moisture and will thereby expand and increase in size. The expanding first part 21′ will apply a force on the dome-shaped second part 21″ that eventually will snap and invert its shape. Thus, the second part 21″ will become convex as shown in FIG. 3b. The first part 21′ of the actuating portion 20 will thus cause the snapping movement of the snapping mechanism 22. This movement of the snapping mechanism 22 causes a characteristic sound to be generated by the sound-generating portion 30, and causes the contact portions 38 of the sound-generating portion 30 to induce the characteristic sound into the structure 50.

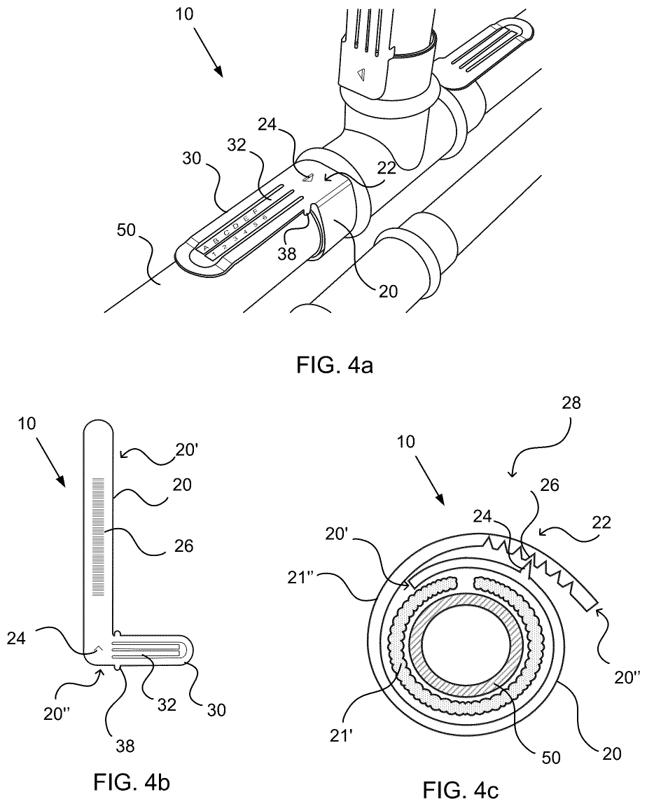

FIG. 4a-c illustrate a converting element 10 according to examples of the present disclosure. The converting element 10 may form part of a system 100 for acoustic detection of a change in moisture as disclosed in FIG. 1. FIG. 4a shows three converting elements 10 arranged on a pipe system constituting the structure 50. The converting elements 10 may be arranged around a pipe coupling, where there is an increased risk for leakage. FIG. 4b shows a converting element 10 as disclosed in FIG. 4a in a flat non-mounted state. FIG. 4c shows a cross-sectional view of another similar example of the converting element 10.

The converting element 10 may be essentially L-shaped in a non-mounted state as shown in FIG. 4b. The actuating portion 20 and the sound-generating portion 30 are thus arranged perpendicularly to each other in the same plane. The sound-generating portion 30 comprises two vibrational elements 32. The vibrational elements 32 may be configured to extend in parallel with the longitudinal extension of the structure 50. The sound-generating portion 30 also comprises at least one contact portion 38 configured to be in physical contact with the structure 50. FIG. 4a shows the contact portion 38 extending perpendicularly to the longitudinal extension of the vibrational elements 32. FIG. 4b shows two contact portions 38 in the flat non-mounted state. When the converting element 10 has been mounted on the structure 50, the contact portions 38 may be bent 90 degrees to be directed towards, and in contact with, the structure 50.

The converting elements 10 shown in FIGS. 4a-c, each has an actuating portion 20, which comprises a snapping mechanism 22. The actuating portion 20 is configured to encircle the structure 50, such that there is an overlapping section 28 of the actuating portion 20. The overlapping section 28 is shown in FIG. 4c and comprises the snapping mechanism 22. In the overlapping section 28, a first end 20′ of the actuating portion 20 is overlapped by a second end 20″ of the actuating portion 20.

The snapping mechanism 22 comprises a resilient part 24 and a plurality of engagement elements 26, the engagement elements 26 and the resilient part 24 being arranged to move in relation to each other in response to a change in moisture, such that the resilient part 24 eventually disengages from an engagement element 26 and springs back, thereby causing the snapping movement. In FIGS. 4a and 4b the converting element 10, or at least the actuating portion 20, is made of a hygroscopic material, such that it reacts to a change in moisture whereby the diameter of the encircling actuating portion 20 changes and the resilient part 24 and the engagement elements 26 moves in relation to each other. In FIG. 4c, the actuating portion 20 comprises a first part 21′ with a hygroscopic material prone to absorb moisture and a second part 21″ comprising the snapping mechanism 22. The first part 21′ is arranged closest to the structure 50 and also encircles the structure 50. The first part 21′ will react to a change in moisture by changing in size and thereby cause a movement of the second part 21″ of the actuating portion 20, such the diameter of the encircling second part 21″ changes and the resilient part 24 and the engagement elements 26 moves in relation to each other. Thus, when there is a change in moisture, the resilient part 24 will build up energy as it flexes against an engagement element 26. As the resilient part 24 and the engagement element 26 continue to move in relation to each other, the resilient part 24 will eventually quickly release the energy and spring back at the other side of the at engagement element 26. The resilient part 24 may thus have a stable state on each side of the engagement element 26. The first part 21′ of the actuating portion 20 will thus cause the snapping movement of the snapping mechanism 22. The movement of the snapping mechanism 22 will bring the vibrational elements 32 into vibration and the sound-generating portion 30 will generate the characteristic sound and induce it into the structure 50 via the contact portions 38.

The engagement elements 26 are grooves, recesses or bulges. The resilient part 24 is a protrusion, spike, needle, tooth or similar. The resilient part 24 and the engagement elements 26 are arranged on opposite facing sides of the first end 20′ and the second end 20″ of the actuating portion 20, in the overlapping section 28. In FIGS. 4a and 4b, the resilient part 24 is arranged at the second end 20″ of the actuating portion 20, protruding downwards towards the first end 20′ of the actuating portion 20. The engagement elements 26 are thus arranged at the first end 20′ of the actuating portion 20. In FIG. 4c, the resilient part 24 is arranged at the first end 20′ of the actuating portion, protruding upwards towards the second end 20″ of the actuating portion 20. The engagement elements 26 are thus arranged at the second end 20″ of the actuating portion 20.

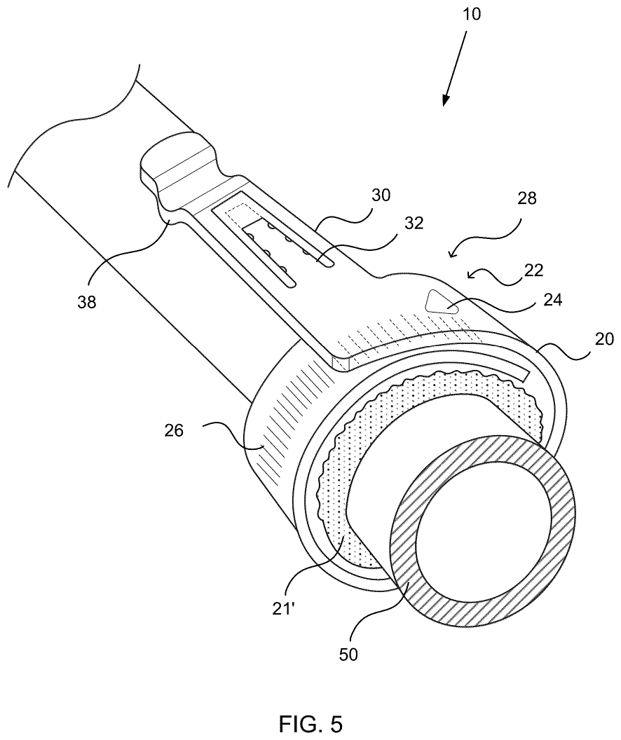

FIG. 5 illustrates a converting element 10 according to an example of the present disclosure. The converting element 10 may form part of a system 100 for acoustic detection of a change in moisture as disclosed in FIG. 1. The figure shows the converting element 10 arranged on a pipe or tube constituting the structure 50. In this example, the converting element 10 is configured similarly to the converting elements 10 shown in FIG. 4a-c, but the contact portion 38 of the sound-generating portion 30 is different. The actuating portion 20 may optionally comprise a first part 21′ comprising a hygroscopic material, the first part 21′ being different from the part of the actuator portion 20 comprising the snapping mechanism 22.

The converting element 10 comprises a sound-generating portion 30 extending perpendicularly to the actuating portion, in the same plane. The sound-generating portion 30 is elongated and comprises one integrated vibrational element 32. The vibrational element 32 is a cutout in the sound-generating portion 30. At a free end of the sound-generating portion 30, the sound-generating portion 30 comprises a downward bend configured to abut the structure 50. The downward bend thus constitutes the contact portion 38. When the actuating portion 20 reacts to a change in moisture is will cause a snapping movement of the snapping mechanism 22. The movement of the snapping mechanism 22 will bring the vibrational element 32 into vibration and cause the characteristic sound to be generated. The characteristic sound is then induced into the structure 50 by means of the contact portion 38 of the sound-generating portion 30.

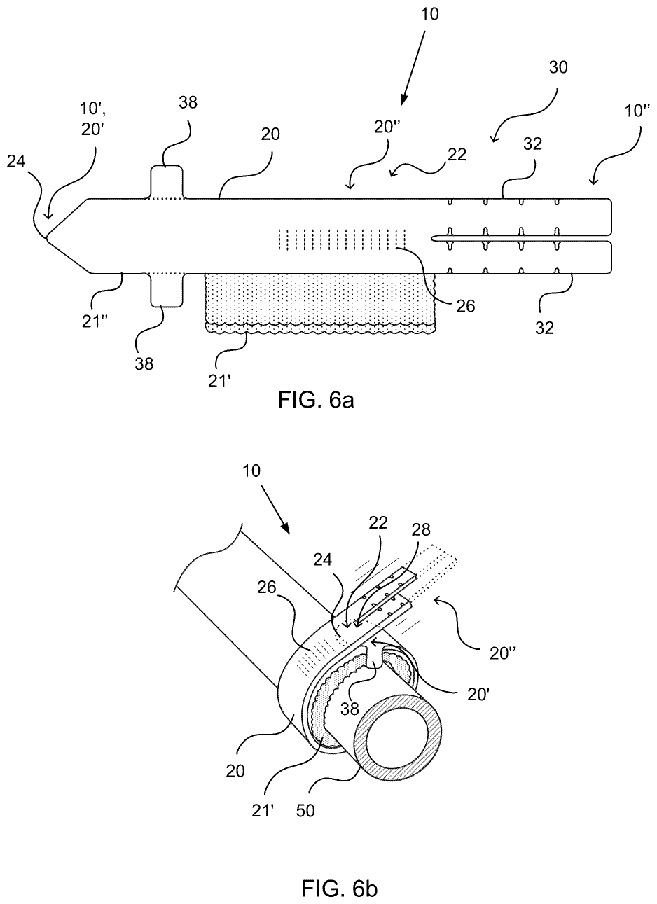

FIG. 6a-b illustrate a converting element 10 according to an example of the present disclosure. The converting element 10 may form part of a system 100 for acoustic detection of a change in moisture as disclosed in FIG. 1. FIG. 6b shows the converting element 10 arranged on a pipe or tube constituting the structure 50.

In this example, the converting element 10 is elongated and essentially flat in a non-mounted state as shown in FIG. 6a. The converting element 10 comprises an actuating portion 20 and a sound-generating portion 30 comprising two vibrational elements 32. The vibrational elements 32 are a prolongation of the actuating portion 20. Thus, the actuating portion 20 and the vibrational elements 32 are arranged after each other along the longitudinal extension of the converting element 10. The converting element 10 comprises a first end 10′ and a second end 10″. The two vibrational elements 32 are configured as two parallel legs at the second end 10″ of the converting element 10. The first end 10′ of the converting element 10 is tapered. The sound-generating portion 30 also comprises two contact portions 38 configured to be in physical contact with the structure 50. FIG. 6a shows the contact portions 38 extending from the actuating portion 20 perpendicularly to the longitudinal extension of the converting element 10. When the converting element 10 has been mounted on the structure 50, the contact portions 38 may be bent 90 degrees to be directed towards, and in contact with, the structure 50.

The actuating portion 20 comprises a snapping mechanism 22. The actuating portion 20 comprises a first part 21′ with a material prone to adsorb or absorb moisture and a second part 21″ comprising the snapping mechanism 22. The actuating portion 20 is configured to encircle the structure 50, such that there is an overlapping section 28 of the second part 21″ of the actuating portion 20. The first part 21′ is arranged closest to the structure 50 and also encircles the structure 50. The overlapping section 28 is shown in FIG. 6b and comprises the snapping mechanism 22. In the overlapping section 28, a first end 20′ of the second part 21″ of the actuating portion 20 is overlapped by a second end 20″ of the second part 21″ of the actuating portion 20. Also, the vibrational elements 32 will overlap the first end 20′ of the second part 21″ of the actuating portion 20. It is to be understood that the first part 21′ of the actuating portion 20 could be omitted and in that case, the second part 21″ of the actuating portion 20 comprises a hygroscopic material prone to absorb or adsorb moisture.

The snapping mechanism 22 comprises a resilient part 24 and a plurality of engagement elements 26, the engagement elements 26 and the resilient part 24 being arranged to move in relation to each other in response to a change in moisture, such that the resilient part 24 eventually disengages from an engagement element 26 and springs back, thereby causing the snapping movement. The resilient part 24 in this example is a tip formed at the first end 20′ of the second part 21″ of the actuating portion 20. The first part 21′ of the actuating portion 20 will react to a change in moisture by changing in size (expanding or contracting) and thereby cause a movement of the second part 21″ of the actuating portion 20, such the diameter of the encircling second part 21″ of the actuating portion 20 changes and the resilient part 24 and the engagement elements 26 moves in relation to each other. Thus, when there is a change in moisture, the resilient part 24 will build up energy as it flexes against an engagement element 26. As the resilient part 24 and the engagement element 26 continue to move in relation to each other, the resilient part 24 will eventually quickly release the energy and spring back at the other side of the at engagement element 26. The resilient part 24 may thus have a stable state on each side of the engagement element 26. It is to be understood that the engagement elements 26 also may be somewhat resilient. The first part 21′ of the actuating portion 20 will thus cause the snapping movement of the snapping mechanism 22. The movement of the snapping mechanism 22 will bring the vibrational elements 32 into vibration and the sound-generating portion 30 will generate the characteristic sound and induce it into the structure 50 via the contact portions 38. The engagement elements 26 are grooves, recesses or bulges.

It is to be understood that the at least one resilient part 24 of the snapping mechanism 22 may be a plurality of resilient protrusions forming recesses at the second end 20″ of the second part 21″ of the actuating portion 20, and the engagement element 26 may the tip of the second part 21″ of the actuating portion 20.

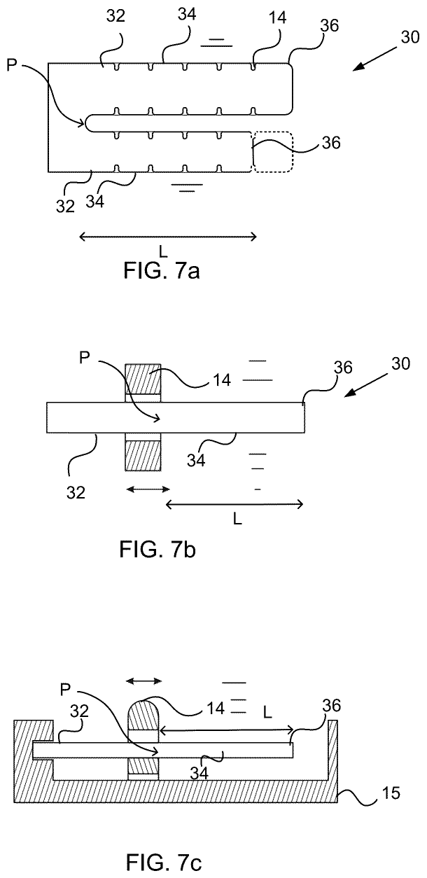

FIGS. 7a-c illustrate details of a converting element 10 according to examples of the present disclosure. These figures specifically shows a vibrational element 32 of a sound-generating portion 30 of a converting element 10. The converting element 10 may be configured as disclosed in any of the previous figures. The actuating portion 20 and other parts of the converting element 10 have been omitted from these figures for clarity.

The vibrational element 32 comprises a vibrational portion 34 extending between a pivot point P and a free end 36 of the vibrational element 32. The vibrational portion 34 is thus the part of the vibrational element 32 that is able to vibrate. The pivot point P is defining the fixed point from which the vibrational portion 34 is extending. The converting element 10 may comprise means 14 for manually adjusting the length L of the vibrational portion 34 in order to manually affect at least one characteristic frequency and/or a plurality of frequencies forming a characteristic sequence of frequencies of the characterizing sound generated by the converting element 10. By manually adjusting the length L of the vibrational portion 34, a specific and unique identity can be given to the converting element 10.

FIG. 7a shows a sound-generating portion 30 with two vibrational elements 32. In this example, the means 14 for adjusting the length L of the vibrational portion 34 of the vibrational elements 32 comprises markings or dentations 14 for bending or removing a part of the vibrational portion 34. The dotted part of the lower vibrational element 32 has been removed and that vibrational portion 34 is thus shorter than the vibrational portion 34 of the upper vibrational element 32. This way, the two vibrational elements 32 will generate different characteristic frequencies when being brought into vibration.

FIGS. 7b and 7c both show solutions where the means 14 for adjusting the length L of the vibrational portion 34 of the vibrational element 32 comprises a slider element movable along the length of the vibrational element 32. The slider element 14 may connect the vibrational element 32 with a fixed support structure 15 and will thereby constitute or define the pivot point P of the vibrational portion 34. The position of the slider element 14 will thus determine the position of the pivot point P of the vibrational element 32. By moving the slider element 14, the pivot point P is moved and the length L of the vibrational portion 34 can be adjusted.

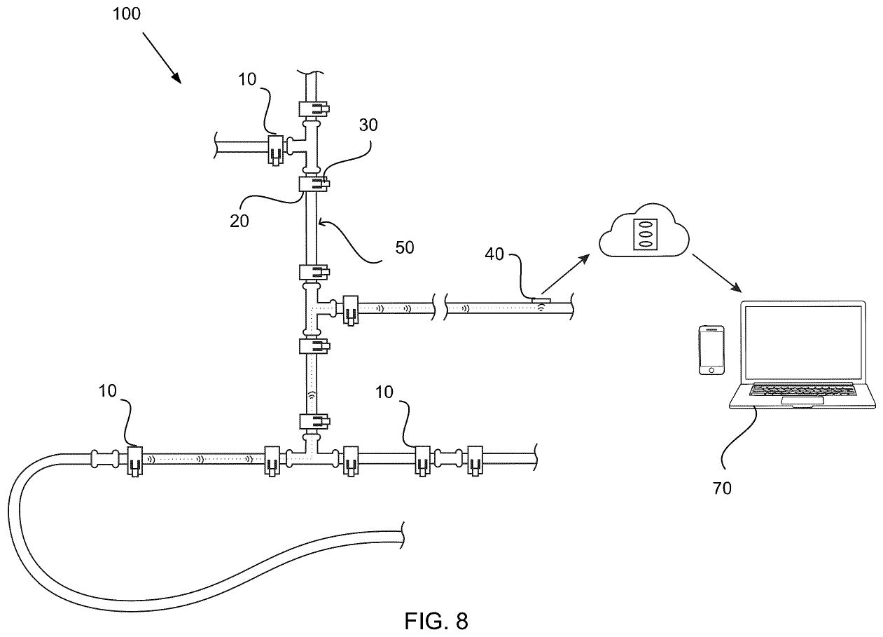

FIG. 8 illustrates a system 100 for acoustic detection of a change in moisture according to an example of the present disclosure. The system 100 may be configured as disclosed in FIG. 1 and the converting elements 10 may be configured as disclosed in FIG. 4a-c, 5, 6a-b or 7a-c. In this example, the system 100 is arranged in association with a piping system, which constitutes the structure 50.

The system 100 comprises a plurality of converting elements 10 arranged in vicinity of pipe connections or couplings of the pipe system 50, and the acoustic sensor 40 is arranged on a pipe of the pipe system 50 at a distance from the converting elements 10. Each converting element 10 comprises an actuating portion 20 and a sound-generating portion 30, which in this example also comprises a vibrational element 32. The actuating portion 20 comprises at least one material having a hygroscopic property, such that a change in moisture causes a change in size and/or shape of the actuating portion and thereby causes a movement of the actuating portion 20, which movement causes a characteristic sound to be generated. The actuating portion 20 may be configured to react to an increase and/or a decrease of moisture.

The characteristic sound created by each converting element 10 in the system 100 is associated with a unique identity and/or position of the converting element 10. The at least one processor 42, 62 (see FIG. 1) of the system 100 is configured to determine a location of the change in moisture based on the unique identity and/or location of the converting element 10 having created the registered characteristic sound. Depending on the location of the converting element 10, the characteristic sound from the converting element 10 propagating through the pipe system will be different. Additionally or alternatively, each converting element 10 may have differently configured vibrational elements 32, such that each converting element 10 is associated with a unique identity. Thus, when the moisture level increases somewhere along the pipe system 50, the corresponding converting element 10 will generate a characteristic sound and the at least one processor 42, 62 will not only detect that an increase in moisture has occurred, but can also, based on the unique identity of the converting element 10, determine where the leakage is in the pipe system 50.

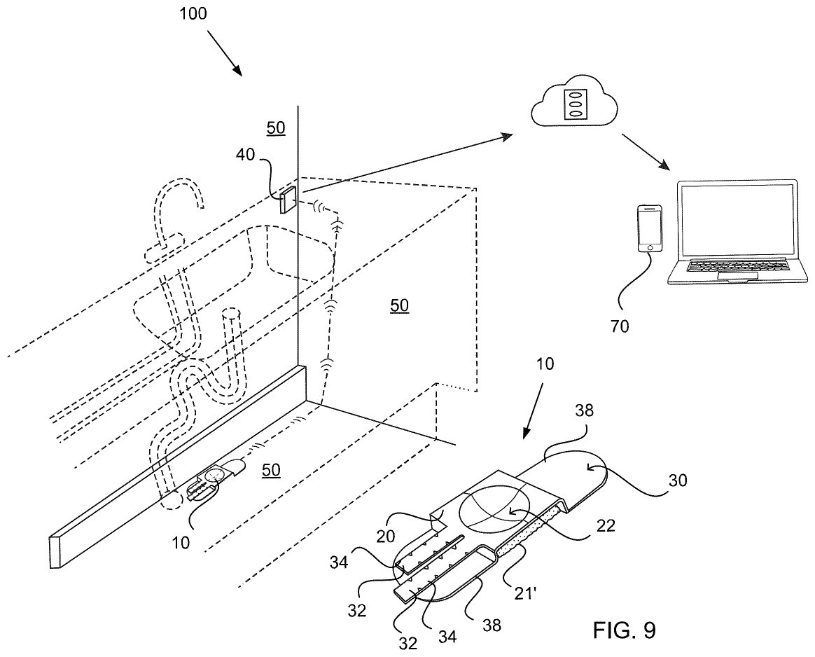

FIG. 9 illustrates a system 100 for acoustic detection of a change in moisture according to an example of the present disclosure. The system 100 may be configured as disclosed in FIG. 1 and the converting elements 10 may be configured as disclosed in FIG. 2a-b, 3a-b or 7a-c. In this example, the system 100 is arranged in association with a sink with a faucet and the converting element 10 is arranged on the floor underneath such sink. The floor and the walls in the room are mechanically connected and together constitutes the structure 50. The acoustic sensor 40 is arranged on the wall, at a distance from the converting element 10.

The figure also shows an enlarged view of the converting element 10. The converting element 10 comprises an actuating portion 20 and a sound-generating portion 30, which in this example also comprises two vibrational element 32. The sound-generating portion 30 also comprises two contact portions 38 configured to be arranged in physical contact with the floor underneath the sink. The actuating portion 20 comprises at least one material having a hygroscopic property, such that a change in moisture causes a movement of the actuating portion 20, which movement causes a characteristic sound to be generated. The actuating portion 20 may be configured to react to an increase and/or a decrease of moisture.

The actuating portion 20 comprises a snapping mechanism 22 configured to perform a snapping movement into a stable state of the snapping mechanism 22 in response to the change in moisture. The snapping movement will propagate in the converting element 10 and cause the sound-generating portion 30 to generate the characteristic sound and induce the characteristic sound into the floor 50 on which the converting element 10 is arranged. The snapping mechanism 22 is a bi-stable mechanism configured with a snap-through instability, configured to perform the snapping movement between a first stable state and a second stable state of the bi-stable mechanism in response to the change in moisture. The snapping mechanism 22 is essentially dome-shaped and is concave in a normal unaffected state of the converting element 10. The actuating portion 20 also comprises a first part 21′ with a first material being prone to absorb or adsorb moisture. When the moisture level increases, the first part 21′ will absorb or adsorb the moisture and will thereby expand and increase in size. The expanding first part 21′ will apply a force on the dome-shaped snapping mechanism 22, which eventually will snap and invert its shape. Thus, the snapping mechanism 22 will become convex. The first part 21′ of the actuating portion 20 will thus actuate the snapping movement of the snapping mechanism 22. This movement of the snapping mechanism 22 causes a characteristic sound to be generated by the sound-generating portion 30, and causes the contact portions 38 of the sound-generating portion 30 to induce the characteristic sound into the floor 50.

In this example, the vibrational elements 32 are configured with different lengths of the vibrational portion 34, causing the characteristic sound to comprise at least one two different characteristic frequencies. The snapping mechanism 22 of the actuating portion 20 typically transitions rapidly between the two stable states and the rapid movement from one stable state into the other stable state will bring the vibrational elements 32 into vibration and cause the contact portions 38 of the sound-generating portion 30 to induce the generated characteristic sound into the structure 50.

The acoustic sensor 40 will register the characterising sound and the at least one processor 42, 62 (see FIG. 1) will detect, for example, that there is a leakage in association with the sink and faucet. Information about the detected leakage may be presented on a mobile electronic device 70 of the user, such that the user is informed and can take action if something needs to be done to handle the detected leakage. When the leakage has been stopped, and the moisture level in association with the converting element 10 has decreased, the first part 21′ of the actuating portion 20 will contract and return to the normal state of the converting element 10. The snapping mechanism 22 can then be manually pushed to snap back to the concave state. This way, the converting element 10 can be used several times.

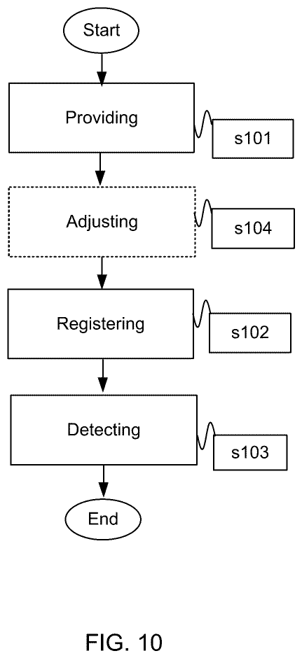

FIG. 10 illustrates an exemplary embodiment of a method for acoustic detection of a change in moisture according to the present disclosure. The method relates to a system 100 for acoustic detection of a change in moisture. The system 100 may be configured as disclosed in any of FIG. 1-9.

The method comprises providing s101 at least one converting element 10 for converting the change in moisture to a characteristic sound, wherein the converting element 10 comprises an actuating portion 20 with at least one material having a hygroscopic property, such that a change in moisture causes a movement of the actuating portion 20, which movement causes the converting element 10 to generate a characteristic sound and induce the characteristic sound into a structure 50.

The method further comprises registering s102 the characteristic sound generated by the converting element 10 as structure-borne sound propagating through the structure 50 by means of an acoustic sensor 40 mechanically connected to the structure 50 at a distance from the at least one converting element 10.

The method also comprises detecting s103 the change in moisture based on the characteristic sound registered by the acoustic sensor 40 by means of at least one processor 42, 62 coupled to the acoustic sensor 40. The processor 42, 62 may receive signals from the acoustic sensor 40 corresponding to the registered characteristic sound and the processor 42, 62 may detect a change in moisture based on the received signals.

The converting element 10 may comprise a sound-generating portion 30 with at least one vibrational element 32 configured to be brought into vibration by the movement of the actuating portion 20, the configuration of the at least one vibrational element 32 causing the characteristic sound to comprise at least one characteristic frequency and/or a plurality of frequencies forming a characteristic sequence of frequencies, wherein the change in moisture is detected s103 based on the at least one characteristic frequency and/or a plurality of frequencies forming a characteristic sequence of frequencies.

The vibrational element 32 may comprise a vibrational portion 34 extending between a pivot point P and a free end 36 of the vibrational element 32 and the method may further comprise adjusting s104 the length L of the vibrational portion 34 in order to manually affect at least one characteristic frequency and/or a plurality of frequencies forming a characteristic sequence of frequencies. This way, the user of the system 100 can manually give each converting element 10 a unique identity and facilitate the use of multiple converting elements 10 on the same structure 50.

The method may comprise the step of providing s101 a plurality of converting elements 10, wherein the characteristic sound created by each converting element 10 is associated with a unique identity and/or location of the converting element 10. The step of detecting s103 a change in moisture may then comprise to determine a location of the change in moisture based on the unique identity and/or position of the converting element 10 having generated the registered characteristic sound.

The person skilled in the art realizes that the present disclosure is not limited to the embodiments described above. The person skilled in the art further realizes that modifications and variations are possible within the scope of the appended claims.

1. A system for acoustic detection of a change in moisture, the system comprising:
at least one converting element for converting a change in moisture to a characteristic sound;
an acoustic sensor configured to be mechanically connected to a structure at a distance from the at least one converting element and
a processor coupled to the acoustic sensor,
wherein the at least one converting element comprises an actuating portion with at least one material having a hygroscopic property, such that a change in moisture causes a movement of the actuating portion, which movement causes the converting element to generate a characteristic sound and induce the characteristic sound into the structure, wherein the acoustic sensor is configured to register the characteristic sound generated by the at least one converting element as structure-borne sound propagating through the structure and the processor is configured to detect the change in moisture based on the characteristic sound registered by the acoustic sensor.

2. The system according to claim 1, wherein the converting element comprises a sound-generating portion with at least one vibrational element configured to be brought into vibration by the movement of the actuating portion the configuration of the at least one vibrational element causing the characteristic sound to comprise at least one characteristic frequency and/or a plurality of frequencies forming a characteristic sequence of frequencies.

3. The system according to claim 2, wherein the at least one vibrational element comprises a vibrational portion extending between a pivot point (P) and a free end of the vibrational element wherein the converting element comprises means for manually adjusting a length of the vibrational portion in order to manually affect at least one characteristic frequency and/or a plurality of frequencies forming a characteristic sequence of frequencies.

4. The system according to claim 2, wherein the actuating portion comprises a snapping mechanism configured to perform a snapping movement into a stable state of the snapping mechanism in response to the change in moisture.

5. The system according to claim 4, wherein the snapping mechanism is a bi-stable mechanism configured with a snap-through instability, configured to perform the snapping movement between a first stable state and a second stable state of the bi-stable mechanism in response to the change in moisture.

6. The system according to claim 4, wherein the snapping mechanism comprises a resilient protrusion and at least one engagement element arranged to move in relation to each other in response to a change in moisture, such that the resilient protrusion eventually disengages from the at least one engagement element and spring back, thereby causing the snapping movement.

7. The system according to claim 6, wherein the actuating portion is configured to encircle the structure such that there is an overlapping section of the actuating portion where a first end of the actuating portion and a second end of the actuating portion are overlapping each other, wherein the resilient protrusion and the at least one engagement element are arranged on facing sides of the first end and the second end of the actuating portion in the overlapping section

8. The system according to claim 7, wherein the actuating portion comprises a first part configured to be arranged closest to the structure and configured to expand or contract in response to the change in moisture, whereby a diameter of the encircling actuating portion changes and the resilient protrusion and the at least one engagement element moves in relation to each other.

9. The system according to claim 2, wherein the sound-generating portion of the converting element comprises at least one contact portion configured to be arranged in physical contact with the structure.

10. The system according to claim 5, wherein the snapping mechanism comprises a dome-shaped part configured to snap-through in response to the change in moisture.

11. The system according to claim 1, wherein the system comprises a plurality of converting elements wherein the characteristic sound created by each converting element, associated with a unique identity and/or position of the converting element the processor being configured to determine a location of the change in moisture based on the unique identity and/or position of the converting element having created the registered characteristic sound.

12. A method for acoustic detection of a change in moisture, the method comprising:
providing at least one converting element for converting the change in moisture to a characteristic sound, wherein the converting element comprises an actuating portion with at least one material having a hygroscopic property, such that a change in moisture causes a movement of the actuating portion which movement causes the converting element to generate a characteristic sound and induce the characteristic sound into a structure;
registering the characteristic sound generated by the converting element as structure-borne sound propagating through the structure by an acoustic sensor mechanically connected to the structure at a distance from the at least one converting element; and
detecting the change in moisture based on the characteristic sound registered by the acoustic sensor by processor coupled to the acoustic sensor.

13. The method according to claim 12, wherein the converting element comprise a sound-generating portion with at least one vibrational element configured to be brought into vibration by the movement of the actuating portion, the configuration of the at least one vibrational element causing the characteristic sound to comprise at least one characteristic frequency and/or a plurality of frequencies forming a characteristic sequence of frequencies, wherein the change in moisture is detected based on the at least one characteristic frequency and/or a plurality of frequencies forming a characteristic sequence of frequencies.

14. The method according to claim 13, wherein the vibrational element comprises a vibrational portion extending between a pivot point and a free end of the vibrational element the method further comprising:
adjusting a length of the vibrational portion in order to manually affect at least one characteristic frequency and/or a plurality of frequencies forming a characteristic sequence of frequencies.

15. The method according to claim 12, comprising the step of providing a plurality of converting elements wherein the characteristic sound created by each converting element is associated with a unique identity and/or location of the converting element, and wherein the step of detecting the change in moisture comprises to determine a location of the change in moisture based on the unique identity and/or location of the converting element having created the registered characteristic sound.
